(19) United States
(12) Patent Application Publication
(10) Pub. No.: US 2017/0035249 A1
(43) Pub. Date: Feb. 9, 2017

(54) INGREDIENT SCALE SYSTEM AND METHODS

(71) Applicant: BlendTec, Inc., Orem, UT (US)

(72) Inventors: Thomas D. Dickson, JR., Orem, UT (US); Kenneth Dinkel, Springville, UT (US); David J. Throckmorton, Mapleton, UT (US)

(73) Assignee: BlendTec, Inc., Orem, UT (US)

(21) Appl. No.: 15/144,239

(22) Filed: May 2, 2016

Related U.S. Application Data
(60) Provisional application No. 62/129,333, filed on Mar. 6, 2015.

(51) Int. Cl. A47J 43/04

(52) U.S. Cl. CPC A47J 43/04; A23P 1/00

(57) ABSTRACT

A food preparation system includes an application operable by a computing device, and a scale configured to support a food preparation container and wirelessly communicate weight information associated with the food preparation container wirelessly to the computing device. The application coordinates the weight information with ingredients of a recipe.

### RELATED APPLICATION

This claims the benefit of U.S. Provisional Application No. 62/129,333, filed 6 Mar. 2015, which is hereby incorporated by reference herein in its entirety.

### TECHNICAL FIELD

The present disclosure relates generally to food preparation apparatuses, systems, and methods and relates particularly to ingredient scales and related methods of measuring weight when carrying out a recipe.

### BACKGROUND

Food preparation typically includes following a recipe that includes a list of ingredients and instructions for measure and mixing ingredients, cooking, baking, etc. At least some types of food preparation requires the use of a food preparation device such as a food mixing machine (e.g., mixer), blender, food processor, oven, microwave, grill, stove top, and the like. Ingredients are usually separately measured and placed in a food preparation container prior to using the food preparation device. The use of measuring devices and separate food preparation containers when preparing a recipe results in many objects being used, which requires additional clean up, time and cost.

Additionally, many types of recipes require precise measurement of ingredients in order to obtain the desired finished food product. Some ingredients must be measured by weight while others are measured by volume. Inconsistencies in measuring devices, particularly when using a combination of weight and volume to obtain the measured amounts, may result in significant variation in the end food product when different people prepare the same recipe or when the same person prepares the same recipe at different times.

Furthermore, many variations are possible for a given food recipe or finished food product. The ingredients used in a recipe are directly associated with the number of calories, a nutritional value, a sweetness index, a salt content, and other characteristics of the finished food product. For most people preparing food, it is difficult to know what ingredients may be substituted for others in order to influence any of these characteristics of the end food product while still being able to obtain a desired outcome. Further, as a person learns about ingredients or ways to customize a recipe, it is often difficult to capture what the person has learned so that the person does not have to re-learn those same things when preparing the same recipe in the future.

There is therefore a need for improvements in food preparation and particularly in accurately measuring ingredients and adjusting recipes.

### SUMMARY

According to one aspect of the present disclosure, a food preparation system includes an application operable by a computing device, and a scale configured to support a food preparation container and communicate weight information associated with the food preparation container wirelessly to the computing device. The application coordinates the weight information with ingredients of a recipe.

The food preparation system may also include a blender having a removable blending jar, wherein the food preparation container includes the removable blending jar. The food preparation system may include a food mixing machine having a removable bowl, wherein the food preparation container includes the removable bowl. The computing device may communicate with the scale using a wireless connection. The application may identify the food preparation container based on the weight information. The application may communicate information to one or more users corresponding to a weight of one or more ingredients relative to a target weight for the one or more ingredients. The application may communicate the information via at least one of a speaker or display screen of the computing device. The application may be operable to receive inputs from a user regarding at least one of available ingredients, serving size, and condition of ingredients.

Another aspect of the present disclosure relates to a weighing method. The method includes receiving weight information from a scale via a wireless communication, the weight information including at least a container weight of a food preparation container supported on the scale, comparing the container weight to stored weight information for a plurality of different food preparation containers, and automatically identifying the food preparation container based on the comparison.

The weight information may include ingredient weight of one or more food ingredients held in the food preparation container, and the method may include comparing the ingredient weight to a target ingredient weight for a recipe. The weight information may include ingredient weight of one or more food ingredients held in the food preparation container, and the method may include generating an indicator when the ingredient weight at least one of approaches and reaches a target weight for a recipe. The indicator may include a visual display of at least one of a color scheme, a numerical value, and a graphical object (e.g., symbol). The indicator may include an audio or tactile indicator.

A further aspect of the present disclosure relates to a food preparation method that includes communicating to a user instructions to add at least one food ingredient of a recipe to a food preparation container, receiving weight information from a scale via a wireless communication, the weight information including ingredient weight related to the at least one food ingredient, comparing the ingredient weight to a stored target weight for the at least one food ingredient, and communicating to the user an indicator regarding the ingredient weight.

The method may include receiving mixing information from a food mixture machine related to mixing the at least one food ingredient in the food preparation container. The indicator may include at least one of a displayed color scheme, a displayed numerical value, a displayed graphical object, and an audio message. The displayed graphical object may illustrate the ingredient weight disproportionately relative to the target weight. The color scheme may include changing colors as the ingredient weight approaches and then reaches the target weight. The numerical value may include at least one of a percentage of the ingredient weight relative to the target weight, and the ingredient weight. The method may include displaying all ingredients of the recipe prior to ingredients being added to the food preparation container, and removing ingredients from the display as the target weight for each ingredient is met. The method may include wirelessly connecting to at least one of a blender and a food mixing machine, and the food preparation container may include at least one of ajar of the blender and a bowl of the food mixing machine.

The method may also include receiving modifications to the recipe via at least one manual input from a user. The method may include displaying at least one question related to the at least one food ingredient, and receiving a response to the question from one or more users. The method may include adjusting at least one of an amount of the at least one ingredient, an instruction of the recipe, and an amount of another ingredient of the recipe in response to the response. The question may relate to at least one of a sweetness scale and a healthy scale for the recipe, and the method may further include adjusting at least one of a sugar content and a calorie content of the recipe based at least in part of the user's response to the question about the sweetness scale and the healthy scale.

Another aspect of the present disclosure relates to a food preparation method that includes receiving weight information wirelessly from a scale, the weight information including ingredient weight related to at least one food ingredient of a recipe and container weight related to a food preparation container holding the at least one food ingredient, receiving operation data wirelessly from one of a blender and a food mixing machine that operates to prepare the at least one ingredient within the food preparation container, and receiving updated weight information wirelessly from the scale, wherein the updated weight information includes ingredient weight related to an additional food ingredient of the recipe.

The operation data may include at least one of power consumption, load, operation speed, and operation duration. The method may include delivering software updates to at least one of the scale, the blender, and the food mixing machine. The weight information and the operation data may be received at a mobile computing device. The method may include adjusting the recipe based at least in part on the operation data. The method may include controlling the at least one of a blender and a food mixing machine wirelessly.

The above summary of the present invention is not intended to describe each embodiment or every implementation of the present invention. The Figures and the detailed description that follow more particularly exemplify a preferred embodiment.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a schematic representation of a food preparation system in accordance with the present disclosure.

FIG. 2 is a schematic representation of another food preparation system in accordance with the present disclosure.

FIG. 3 schematically illustrates an example display in accordance with the present disclosure.

FIG. 4 schematically illustrates an example ingredient indicator in accordance with the present disclosure.

FIG. 5 schematically illustrates an example recipe scale in accordance with the present disclosure.

FIGS. 6-12 are flow diagrams illustrating example food preparation methods in accordance with the present disclosure.

FIG. 13 is a block diagram of a circuit for a controller unit according to the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure may provide improved and effective ways to limit or overcome drawbacks of conventional food preparation systems and methods. One aspect of the present disclosure is directed to a computer application operable by one or more computing devices, wherein the computer application communicates food preparation related information to a user. The computer application may communicate with one or more food preparation devices such as, for example, a scale, blender, mixer, or the like. In one embodiment, the computer application displays the food preparation information such as, for example, a list of ingredients and instructions associated with the recipe. The computer application may receive data from one or more food preparation devices, inputs from a user, and/or information from a database, and provide updates to the ingredients and/or instructions based on the received data.

In one example, the computer application receives weight related data from one or more scales that measures a food ingredient. The computer application may determine when the measured ingredient weight approached and/or reaches a target weight according to the recipe or an amount dictated by a user, and provides a notification to a user of the ingredient weight. In some examples, the ingredient is removed from a list of ingredients displayed by the computer application once the target weight for that particular ingredient has been met.

In another example, the computer application receives weight data related to a food preparation container that is weighed by a scale. The computer application may automatically identify the style, brand, model, or other characteristic of the food preparation container. The computer application may then reference a database of information associated with that particular food preparation container. The identified container (e.g., blending jar, mixing bowl, etc.) and its associated food preparation device (e.g., blender, mixer, etc.) may influence, for example, the type of recipe that is possible, the number of servings, the type of ingredients, preparation time, and the like associated with preparation of a food item.

In a further example, the computer application may route software updates to one or more food preparation devices that are in wireless communication with the computing device that operates the computer application. In at least some examples, the computer application may send instructions to one or more food preparation devices related to operation of that food preparation device. The computer application may receive operational data associated with a food preparation device such as, for example, operation speed, duration, settings, load, and the like. The computer application may use the operational data from the food preparation device as a basis for adjusting a particular recipe prior to or during preparation of the recipe.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

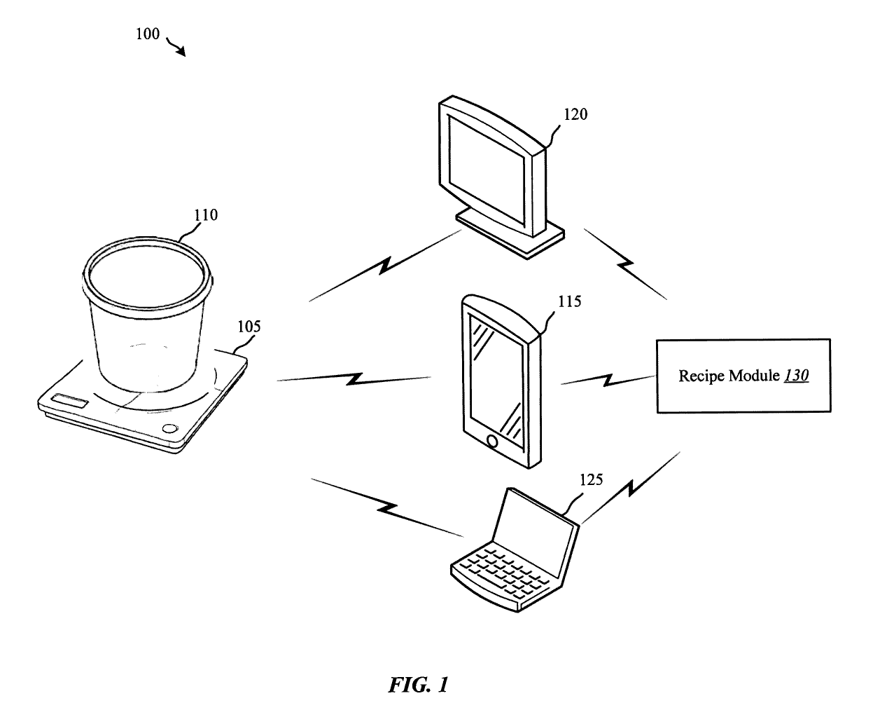

FIG. 1 is a schematic diagram showing an example food preparation system 100 in accordance with the present disclosure. Food preparation system 100 includes a scale 105 configured to support and weigh a food preparation container 110. Scale 105 communicates with a computing device such as, for example, a handheld mobile computing device 115 (e.g. smart phone), a stationary computing device 120 (e.g., desktop computer), and/or a mobile computing device 125 (e.g., a laptop or tablet computer). Any one of the computing devices 115, 120, 125 may operate a recipe module 130, and may be referred to herein generally as a computing device 115. Recipe module 130 may be operated by a processor of one of the computing devices 115, 120, 125. The computing devices 115, 120, 125 may be in communication with each other via, for example, a network so that any or all of the computing devices 115, 120, 125 may be used simultaneously related to operation of the recipe module 130 and/or provide communications with scale 105.

Recipe module 130 may operate as a computer application such as a mobile application for use on a mobile computing device. Recipe module 130 may provide a user interface with the user of the computing device that operates the recipe module 130. The user interface may provide an interactive interface between the recipe module 130 and the user. The recipe module 130 may present one or more questions or inquiries and the computing device may facilitate receipt of inputs from the user to those questions. The computing device may communicate with the user via, for example, a display of the computing device, microphones, speakers, a keyboard attached to or in communication with the computing device, or the like. The information presented to the user may relate to weight data transmitted from the scale 105 to the computing device. In one example, scale 105 transmits weight data related to the container 110, and recipe module 130 may use the weight of container 110 as a baseline for adding ingredients to container 110 as part of carrying out a recipe.

In one embodiment, recipe module 130 is able to identify a make, model or manufacturer of container 110 based on the weight of container 110 received from scale 105. Once recipe module 130 identifies the container 110, recipe module 130 access a variety of information or properties of container 110 and/or its associated food preparation device that may be useful in completing the recipe. For example, the container 110 may be identified as a blending jar of a certain size that is used with a particular blender. Recipe module 130 may be able to determine whether certain types of recipes are possible for that jar and blender, determine whether serving sizes are possible, and generate specific instructions associated with operation of the blender jar or blender. In this way, a recipe and its associated instructions may be customized for the particular container 110 (e.g., blender jar) and food preparation machine (e.g., blender).

Scale 105 may measure ingredients placed in food preparation container 110. The ingredient weight may be transmitted to a computing device operating recipe module 130. Recipe module 130 may provide an indicator to the user related to the weight of the ingredient relative to a target weight for the ingredient according to the recipe being carried out. The indicator may have many different forms, including, for example, a displayed numerical value, a displayed color scheme, a displayed symbol, a displayed non-proportional graphical representation, or an audible or tactile (e.g., vibration) signal or message. The indicator may inform the user that the target weight is being approached and/or has been reached. The indicator may provide updates as the ingredient weight approaches the target weight and a unique indicator when the target weight is attained.

Recipe module 130 may be provided with predefined threshold values that define when a target weight has been reached. For example, when the measured weight is determined to be within a range of about ±5% of the target weight, and more particularly ±2% of the target weight, recipe module 130 may generate a indicator that the target weight has been reached.

In the case of a numerical value, recipe module 130 may display on one or more of computing devices 115, 120, 125 the actual weight of the ingredient being added to container 110. The numerical value may be a percentage value representing the measured weight relative to the target weight. In another example, the numerical value may be generic representation of the actual weight compared to a target weight using a scale of 1 to 10 so that the user can see how the ingredient weight being added to container 110 compares to the target weight. The scaled representation may be disproportional.

Examples of a color scheme include, for example, a displayed green color, followed by a displayed yellow color, and followed by a displayed orange color as the measured ingredient weight approaches the target weight. A red color may be displayed when the ingredient weight matches the target weight. The color scheme may provide a changing color proportional to the increase in ingredient weight. In other examples, the color scheme may disproportionately apply to different colors. In the example above, the green color may be displayed during the first 50% of the target weight and the other colors may represent other percentages such as the next 30% for yellow, the next 15-20% for orange, and red in the last 0-5%.

In the example of a symbol, the symbol may be in the form of a flashing light that increases in flash frequency as the measured ingredient weight approaches the target weight. The flashing light may turn solid when the target weight is reached. Another example symbol may be words or pictures that represent fast speeds and then slower speeds as the target weight is approached, followed by a stop sign symbol when the target weight is attained.

An audible indicator may include, for example, a beep that increases in at least one of speed and volume as the ingredient weight approaches the target weight, with a solid tone projected when the target weight is reached. Another example audible indicator includes spoken instructions such as “slow down” and “stop.”

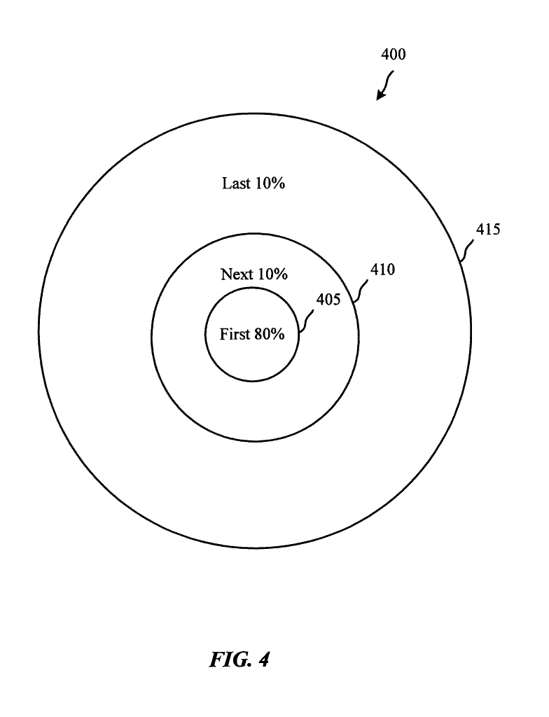

Referring to FIG. 4, an example indicator 400 is shown and described having multiple circles that represent various milestones in reaching a target weight. An internal circle 405 may be filled or highlighted (e.g., with color, shading, hatching, or the like) either in one step or progressively during the first stage of adding an ingredient to container 110. In one example, circle 405 represents a first 80% of the target weight. The next circle 410 may represents a next 10% or 15% of the target weight. The circle 410 may be filled or highlighted in one step or progressively until the next 10% to 15% above the first 80% is filled. The outer ring 415 may represent the last 5% to 10% before reaching the target weight. The outer ring 415 may be filled or highlighted progressively or in one step when the target weight is attained.

A plurality of additional rings may be interposed between any one of the rings 405, 410, 415. In some examples, each of the rings 405, 410, 415 may be filled with various colors, shading, hatching and the like. The visual representation provided by indicator 400 may be coupled with other types of indicators such as, for example, the audible indicator described above.

In at least some examples, recipe module 130 may display a list of ingredients for the user to track while completing a recipe. The ingredients may be removed from the list or in some way highlighted or delineated once a target weight has been attained for that particular ingredient.

Recipe module 130 may generate a list of ingredients and associated amounts for each of the ingredients prior to allowing the user to proceed with carrying out the recipe. For example, recipe module 130 may receive input from a user about the number of servings, a health or sweetness scale for the recipe, information about the food preparation device, and the like, and then generate the list of ingredients and their associated amounts for that customized recipe. The recipe module 130 may request confirmation from the user that the user has all of the ingredients and the necessary amounts available prior to providing further instructions that would permit the user to carry out the recipe.

Recipe module 130 may provide additional functionality including, for example, displaying ratings for a particular recipe or receiving a review or rating from a user, and providing a search field to look up recipes, nutritional information, alternative ingredients, and the like. Recipe module 130 may also operate to provide an adjustable sweetness scale or other recipe scale associated with, for example, a healthy factor, a nutritional factor, or the like, and provide options for the user to modify a recipe, add notes associated with the recipe, etc.

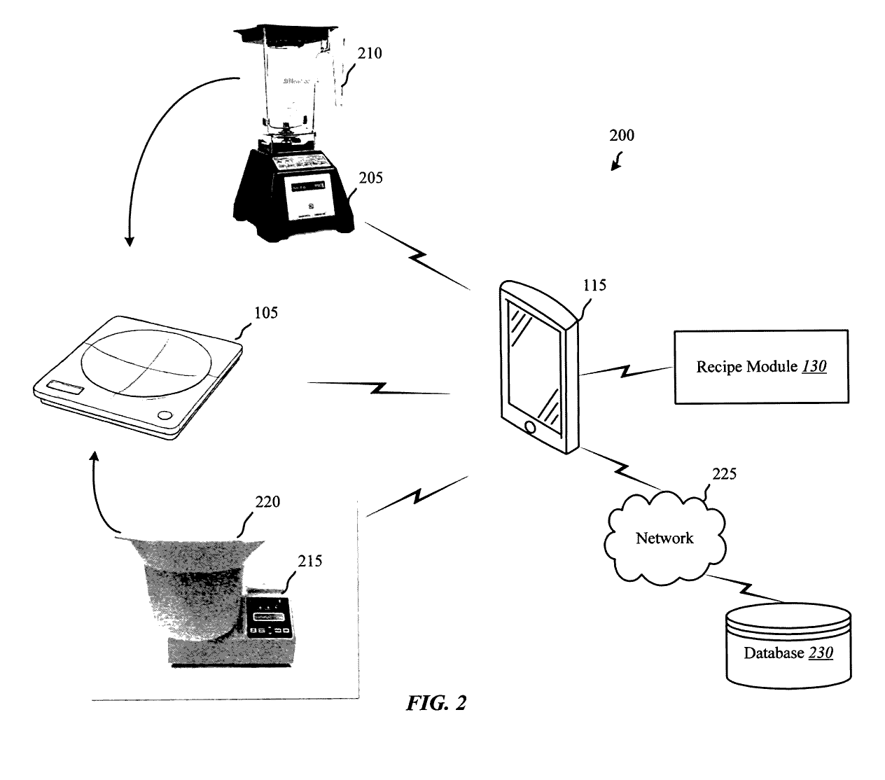

FIG. 2 shows another example food preparation system 200 that includes scale 105, computing device 115, and recipe module 130 in addition to a blender 205 having a blending jar 210, a food mixing machine 215 having a mixing bowl 220, a network 225, and a database 230. Scale 105 may support and weigh any desired food preparation container such as, for example, blending jar 210 or mixing bowl 220. Weight data associated with a container may be transmitted from scale 105 to computing device 115 and recipe module 130 for whatever container 110 is supported on scale 105. Recipe module 130 may use the container weight information to identify the container 110. In some examples, recipe module 130 may reference database 230 for stored information related to the container and/or container weight. Database 230 may be stored on computing device 115. In some examples, database 230 may be accessible via network 225. Although network 225 is shown interposed between only computing device 115 and database 230, network 225 may also facilitate communications between computing device 115 and/or recipe module 130 and other devices such as, for example, scale 105, blender 205, food mixing machine 215, and other food preparation devices and computing devices.

Database 230 may include a database of information regarding one or more of blender 205, blender jar 210, food mixing machine 215, mixing bowl 220, scale 105, and various other types of food preparation containers that may be supported and weighed by scale 105. Database 230 may also include a database of food related information such as, for example, recipes, nutritional information, ingredient information, recipe ratings, and the like.

The network 225 may be used to facilitate communications between any of the components of food preparation systems 100, 200. Examples of the network 225 include cloud networks, local area networks (LAN), wide area networks (WAN), virtual private networks (VPN), wireless networks (using 802.11, for example), and/or cellular networks (using 3G and/or LTE, for example), etc. The network 225 may be a single network, or may include multiple interconnected, overlapping, or coincidental networks. For example, in some embodiments, the network 225 may include multiple networks interconnected to facilitate communication or may include redundant networks. For example, the network 225 may represent a first network (e.g., the Internet) and a second network (e.g., cellular networks). The network 225 and other communications between various components of the food preparation systems disclosed herein may include a radio frequency (RF) system, a wireless network connection (e.g., wi-fi), or a Bluetooth® or Zigbee® connection.

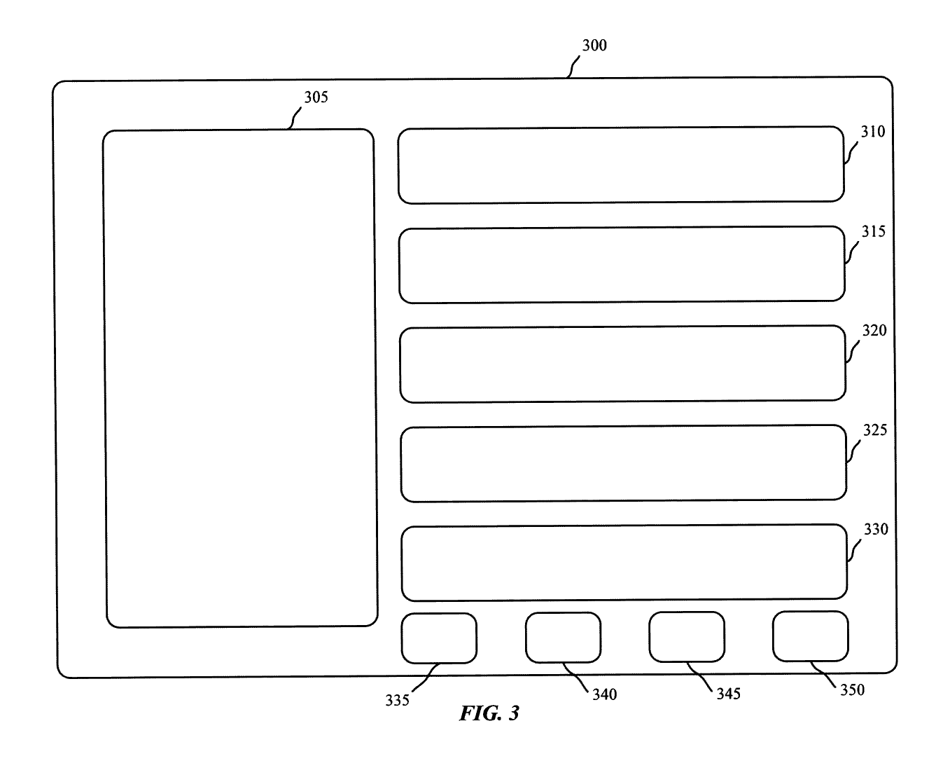

FIG. 3 illustrates a display 300 for a computing device. Display 300 may be a display for any one of the computing devices 115, 120, 125 described with reference to FIGS. 1 and 2, or a food preparation device. Display 300 may divided into a plurality of display portions that provide active areas, user interface features, and the like to facilitate communications with a user. The display 300 shows a particular layout for a variety of such display features, but may include other features, layouts, etc. in other embodiments.

Display 300 is shown including an ingredient/instruction field 305, an inquiry field 310, a search field 315, a user input field 320, a recipe scale field 325, and a nutritional information field 330. Display 300 may also include other features including, for example, a speaker 335, a microphone 340, a camera 345, and an entry/accept indicator 350. Any of the fields or features of display 300 shown in FIG. 3 may be replaced with other features or functions. In at least some examples, activating or operating within any of the fields or features of display 300 may automatically display a keyboard or other user interface field within display 300 while other of the fields or features may be deactivated or removed from view.

Ingredient/instruction field 305 may list instructions for operating the computing device and/or instructions for carrying out a recipe. The displayed instructions may be modified based on, for example, user inputs, available ingredients, weight information received from, for example, scale 105, operational data received from, for example, blender 205, food mixing machine 215, or other food preparation device, and the like. The ingredients and the amount of the ingredient may be displayed. The list of ingredients and their associated amounts may depend on, for example, various user inputs such as, for example, a response to various inquiries presented in inquiry field 310, a recipe scale entered in or adjusted via recipe scale field 325, user feedback to inquiries or messages provided via speaker 335 and/or microphone 340, or information collected via camera 345. The listed ingredients may be presented for viewing by a user or removed from view depending on, for example, whether the ingredient has been added to a food preparation container 110 as part of completing a recipe.

An indicator may be presented on field 305 in association with one or more ingredients being added to food preparation container 110. For example, the indicator 400 shown and described with reference to FIG. 4 may be displayed in field 305 associated with a particular ingredient of a recipe being carried out via display 300. Other indicators include, for example, numerical values, color schemes, symbols, and audible signals as described above with reference to FIGS. 1 and/or 2. Once an ingredient has been added to the food preparation container 110 to and a target weight according to the recipe is confirmed, the indicator may be removed from display in field 305. The ingredients listed in field 305 may also be removed from view as their target weights are attained. A separate indicator may be shown for each ingredient associated with the recipe.

The ingredients and instructions associated with a particular recipe may be shown in separate fields rather than in a common field 305. In some examples, the ingredients and associated instructions for a recipe may be shown in field 305 while the indicator may be provided via other features or functionality of the computing device such as, for example, a camera 345, speaker 335, microphone 340, light generating device (e.g., LED), or the like.

Inquiry field 310 may be used to present various questions or inquiries to a user. For example, inquiry field 310 may present a question such as, for example, how many servings for a recipe, whether particular ingredients are frozen or thawed, what type, model or brand of food preparation container or food preparation device is being used, or whether a food index such as, for example, sweetness, healthiness, saltiness, organic, or other index identifiable by the recipe module 130 will be used.

Search field 315 may provide a field for the user to search for particular recipes, nutritional information, ingredient information, instructions, and the like associated with a recipe, operation of a food preparation device, and the like. The recipe module 130 may receive the search information and reference a database such as database 230 shown in FIG. 2.

User input field 325 may receive input from a user. The inputs may be in response to questions or inquiries presented in inquiry field 310. User input field 320 may provide the user with a way to modify instructions, exchange ingredients of a recipe, enter notes associated with a recipe and/or ingredients, and the like.

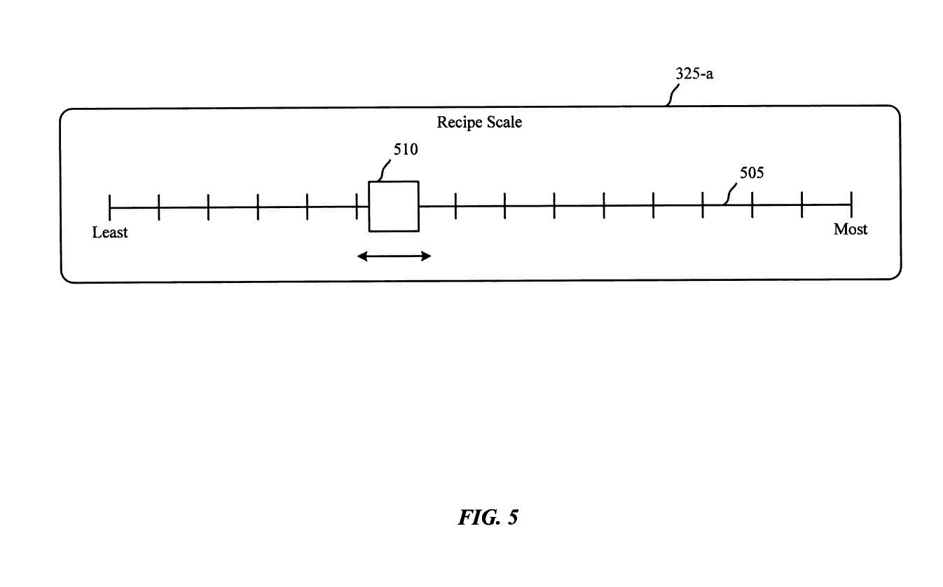

Recipe scale field 325 may provide a user with the ability to adjust a scalable aspect of a recipe. A scale may be presented to the user such as, for example, the scale 505 shown in FIG. 5. The scale may be presented horizontally, vertically, graphically, or in any other desired structure or format. The user may be able to indicate or select a position or location along the scale such as, for example, by moving a marker 510 along scale 505 to a location between a least end of the scale and a most end of the scale as shown in FIG. 5.

The recipe scale may be associated with various adjustable aspects of a recipe such as sweetness, saltiness, nutritional value, kosher rating, organic rating, lactose scale, or gluten content. The sweetness scale may be adjusted by, for example, exchanging various ingredients of the recipe (e.g., exchanging fruits for vegetables, or fruits of lower sugar content for fruits of higher sugar content). A sweetness scale may also be adjusted by, for example, lowering an amount of processed sugar or other sweetener to the recipe. Another scale may be a nutritional scale which is associated with a nutritional content of the recipe. The nutritional content may be adjusted by, for example, exchanging various ingredients or altering an amount of various ingredients. A saltiness factor may be adjusted by, for example, varying an amount of salt or salt products. An organic index related to the organic ingredients of a recipe. A gluten index may be associated with an amount of gluten or gluten substitute for a recipe. Many other types of food indices may be possible and adjustable via a recipe scale presented in the recipe scale field 325.

Nutritional information field 330 may present or provide access to various nutritional information available for a recipe and/or its ingredients. The nutritional information may be available via, for example, a database accessible by the computing device and/or recipe module 130 (e.g., database 230).

The speaker 335 and microphone 340 may facilitate communications between a user and the recipe module 130. For example, the recipe module 130 may present instructions or inquiries to a user via speaker 335. The user may respond with instructions and/or responses via microphone 340. In some examples, speaker 335 may present an indicator related to an ingredient being added to the food preparation container 110. In another example, speaker 335 may present instructions to the user such as, for example, blending or mixing particular ingredients held within the food preparation container 110 prior to adding additional ingredients.

Camera 345 may be used for various purposes such as, for example, providing facial recognition of a user and then adjusting recipes or presenting instructions and/or information based on a recognized user. The camera 345 may be used to capture information about the food item being prepared such as the ingredients being used, or the food preparation container 110. The information collected by camera 345 may be automatically posted, saved and/or distributed by recipe module 130 via, for example, a social media platform.

Entry/accept indicator 350 may provide an additional user input mechanism for a user, or may be used for any other desired purpose in communicating between the computing device and/or recipe module 130 and the user. In other embodiments, the entry/accept indicator 350 may be used for other purposes such as providing a fingerprint scan, pin code entry, or the like to identify the user.

FIG. 5 illustrates a recipe scale associated with a recipe scale field 325-a, which may be one example of the recipe scale field 325 described above with reference to FIG. 3. The recipe scale field 325-a may include a label for a particular recipe scale. The marker 510 may be moved along the scale 505 with a touch input to the display 300 shown in FIG. 3. The marker 510 may be moved using other user inputs besides a touch input such as an audible input. FIG. 5 shows scale 505 as a horizontal scale from least to most, but may be represented in other ways such as, for example, a bar graph or a numerical entry field.

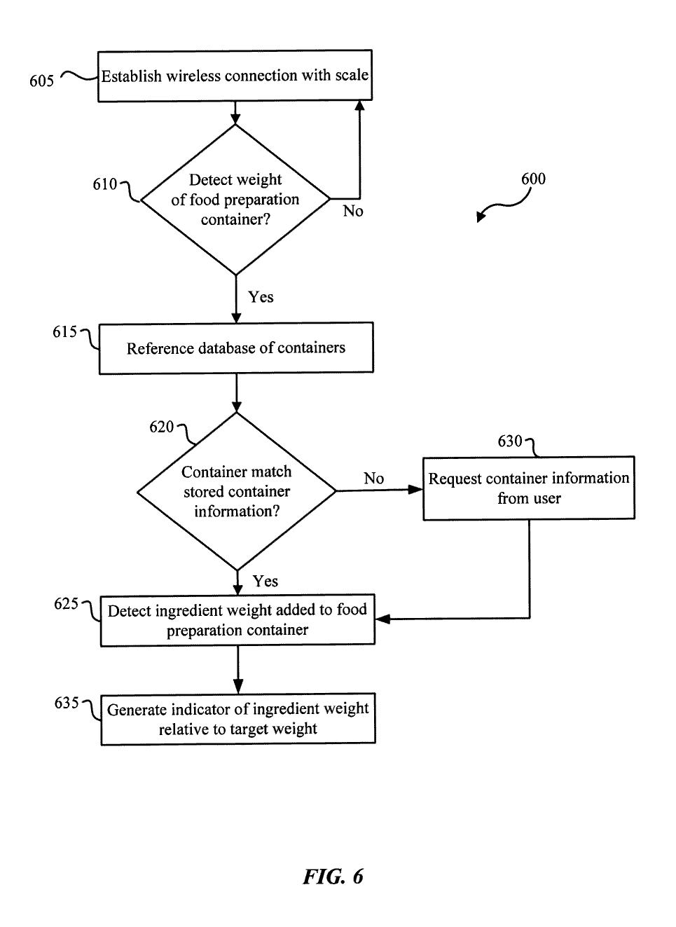

FIG. 6 illustrates a flow diagram of an example food preparation method 600 in accordance with the present disclosure. The method 600 may use any of the features and functionality of the food preparation systems 100, 200 described above with reference to FIG. 2, or other features and functionality associated with FIGS. 3-5.

Method 600 may include at block 605 establishing a wireless connection with a scale, such as scale 105. At block 610, the method 600 inquires whether a food preparation container weight has been detected. If the weight has not been detected, the method returns to block 605 to confirm the wireless connection has been established. If the food preparation container weight has been detected, block 610 includes referencing a database of containers. Block 620 inquires whether the container weight matches stored container information. If the container weight does not match stored container information, block 630 provides requesting container information from the user. The container information may include, for example, a make or model of the container and/or its associated food preparation device. If the container weight does match stored container information, block 625 provides detecting ingredient weight added to the food preparation container. The method 600 may also include generating an indicator of the ingredient weight relative to a target weight at block 635. The indicator may include providing notice to a user that the target weight is being approached so that the user can provide additional accuracy in adding the final amount to reach the target weight.

As described above, the stored container information may be stored on a computing device that operates the recipe module 130 described above with reference to FIGS. 1 and 2. The computing device may be any one of the computing devices 115, 120, 125 described with reference to FIG. 1. In other embodiments, the stored container information may be accessible via a database such as database 230 that is accessible by recipe module 130 via, for example, network 225. The stored container information may include, for example, a maximum volume that may control the number of servings possible for a given recipe, particular types of ingredients that may or may not be handled by that particular container and/or the food preparation device used with the container, and the like.

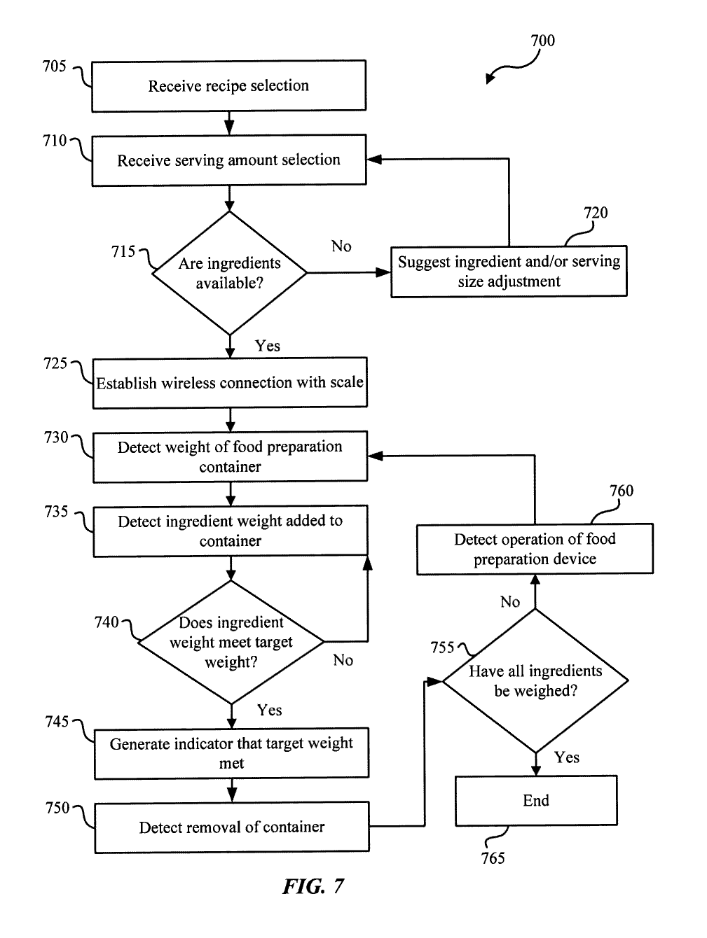

FIG. 7 shows another example food preparation method 700 in accordance with the present disclosure. Method 700 may be carried out using any of the features or functionality of the food preparation systems 100, 200 described above with reference to FIGS. 1 and 2, and other features and functionality described with reference to FIGS. 3-5.

At block 705, method 700 includes receiving a recipe selection. Block 710 includes receiving a serving amount selection associated with the recipe. Block 715 includes an inquiry whether the ingredients are available for the recipe. If the ingredients are not available, block 720 includes suggesting ingredient and/or serving size adjustments for the recipe. Any adjustments to the serving size or ingredients may be accounted for in block 710. If the ingredients are available, block 725 provides establishing a wireless connection with a scale. Block 730 includes detecting the weight of a food preparation container, and block 735 includes detecting ingredient weight added to the container.

Block 740 includes an inquiry whether the ingredient weight meets a target weight. If the ingredient weight does not meet a target weight according to the recipe, the method returns to block 735 to continue detecting the ingredient weight added to the container until the target weight is achieved. If the target weight is achieved, block 745 includes generating an indicator that the target weight has been met. Block 750 includes detecting removal of the container. Block 755 includes an inquiry whether all ingredients have been added and/or weighed according to the recipe if the container has been removed. If all ingredients have been add and/or weighed, the method may end at block 765. If not all ingredients have been added and/or weighed, the method 700 may return to block 730 to attempt to detect weight of the food preparation container at block 730 and/or to detect ingredient weight added to the container at block 735.

Method 700 may include detecting operation of a food preparation device at block 760. The detected operation may confirm that an intermediate mixing or blending step is occurs between the addition of ingredients of the recipe. Detected operational information from the food preparation device may be taken into consideration as part of an ongoing recipe and preparation of a final food product. For example, the detected operational information may include load, mixing/blending duration, operational speed, and the like. Such operational information may be considered as the basis for altering instructions such as, for example, mixing speed, duration, and the like for future mixing and/or blending steps after further ingredients have been added.

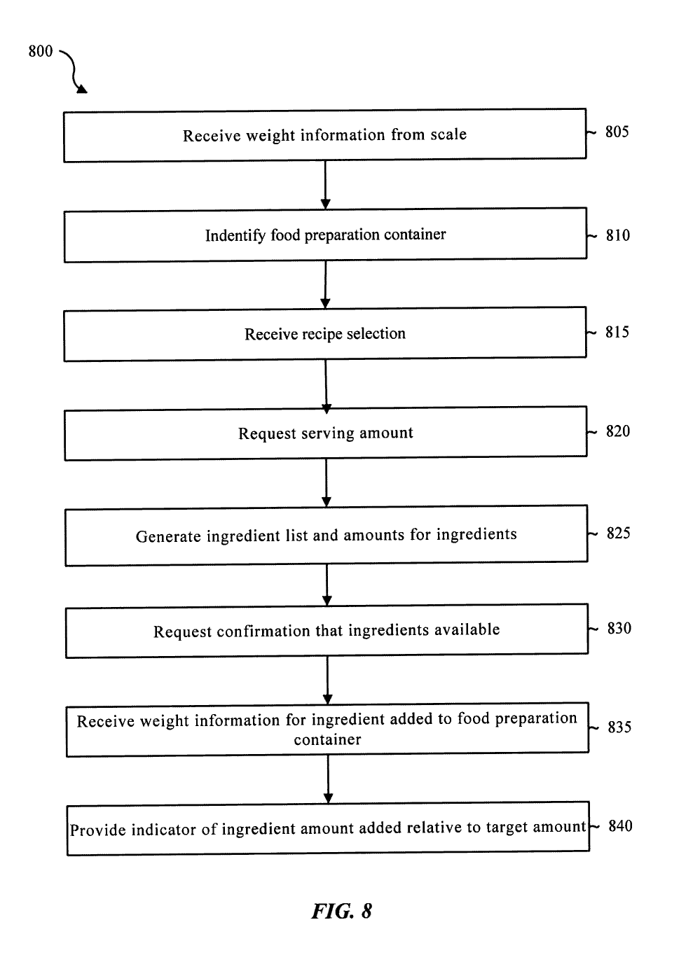

FIG. 8 is a flow diagram illustrating another example food preparation method 800 in accordance with the present disclosure. Method 800 may be carried out using any of the features or functionality of the food preparation systems 100, 200 described above with reference to FIGS. 1 and 2, or the other features and functionality described with reference to FIGS. 3-5.

Method 800 may include at block 805 receiving weight information from a scale. Block 810 may include identifying a food preparation container based on the weight information. Block 815 may include receiving a recipe selection. Block 820 includes requesting a serving amount (e.g., number of servings). Block 825 includes generating an ingredient list and amounts of the ingredients. Block 830 includes requesting confirmation that the ingredients and their associated amounts are available. Block 835 includes receiving weight information for ingredients added to the food preparation container. Block 840 includes providing an indicator of an ingredient amount added to the food preparation container relative to a target amount for that ingredient.

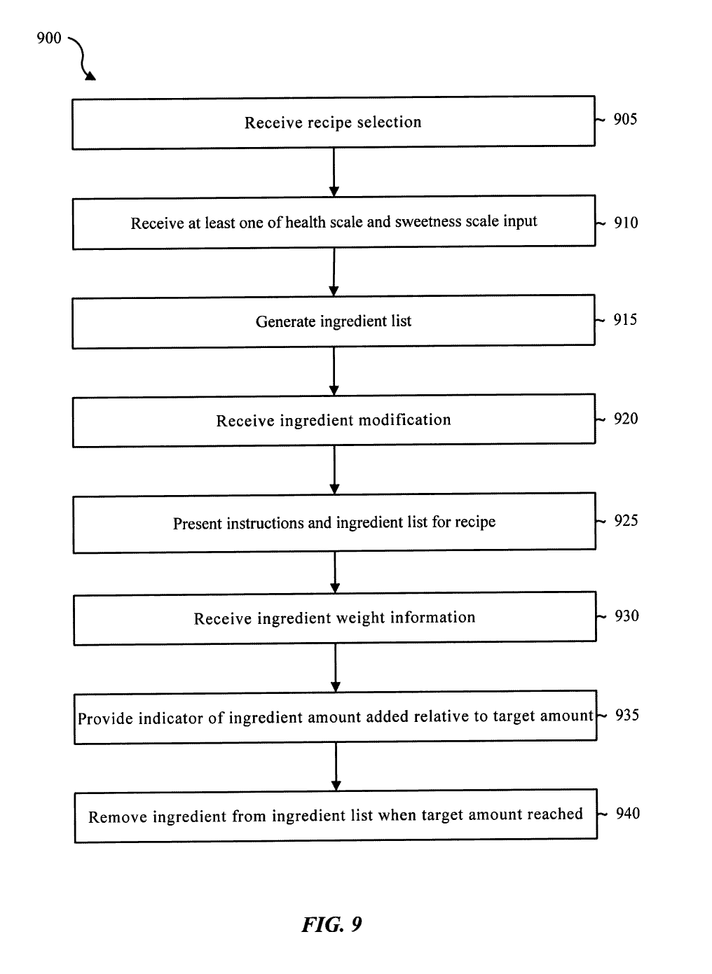

FIG. 9 illustrates another flow diagram for a food preparation method 900 in accordance with the present disclosure. Method 900 may be carried out using any of the features or functionality of the food preparation systems 100, 200 described above with reference to FIGS. 1 and 2, or the other features and functionality described with reference to FIGS. 3-5.

Method 900 may include at block 905 receiving a recipe selection. Block 910 includes receiving at least one of a health scale and a sweetness scale input, or other recipe scale input. Block 915 includes generating an ingredient list. Block 920 includes receiving an ingredient modification (e.g., from a user input). Block 925 includes presenting instructions and an ingredient list for the recipe. In one example, the instructions may be presented via display 300 described with reference to FIG. 3, or via an audio instruction. Block 930 includes receiving ingredient weight information. The ingredient weight information may be received wirelessly from, for example, scale 105. Block 935 includes providing an indicator of the ingredient amount added relative to a target amount. The target amount may be set in accordance with the recipe. Block 940 includes removing an ingredient from the ingredient list when the target amount is reached for that particular ingredient.

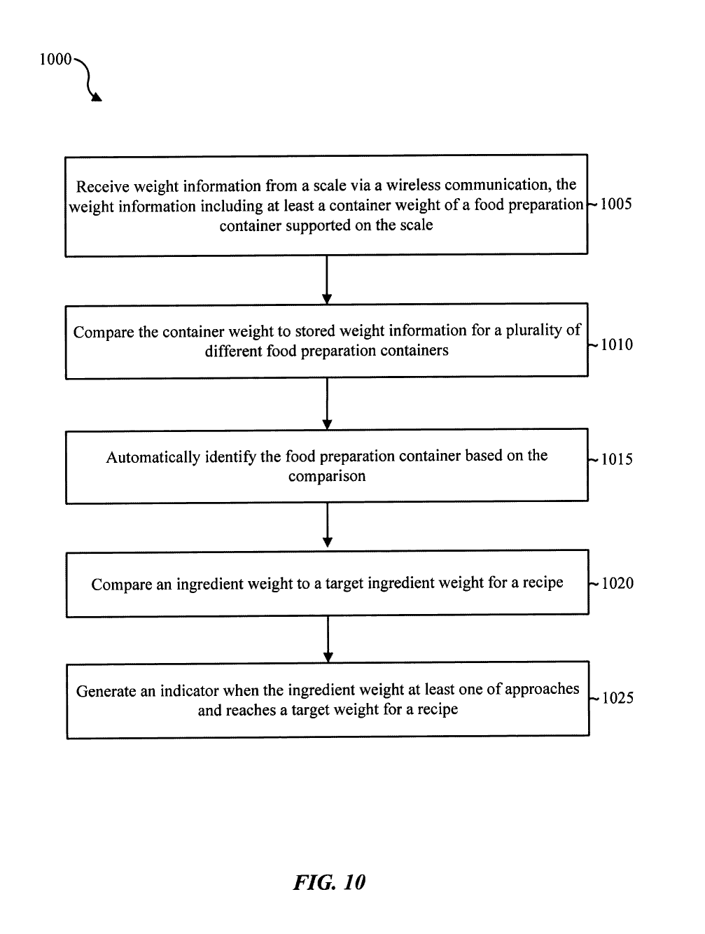

FIG. 10 illustrates another food preparation method 1000 in accordance with the present disclosure. Method 1000 may be carried out using any of the features or functionality of the food preparation systems 100, 200 described above with reference to FIGS. 1 and 2, or the features and functionality described with reference to FIGS. 3-5.

Method 1000 includes at block 1005 a step of receiving weight information from a scale via a wireless communication. The weight information may include at least a container weight of a food preparation container supported on the scale. Block 1010 includes comparing the container weight to stored weight information for a plurality of different food preparation containers. Block 1015 includes automatically identifying the food preparation container based on the comparison. Block 1020 includes comparing an ingredient weight to a target ingredient weight for a recipe. The ingredient weight may be determined by the scale. The ingredient may be added to the food preparation container. At block 1025, the method 1000 includes generating an indicator when the ingredient weight approaches and/or reaches a target weight for a recipe. As described above, the indicator may be a visual indicator that disproportionately shows how the weight of the ingredient is approaching the target weight. The indicator may include, for example, a color scheme, a symbol, a numerical value, or an audible signal.

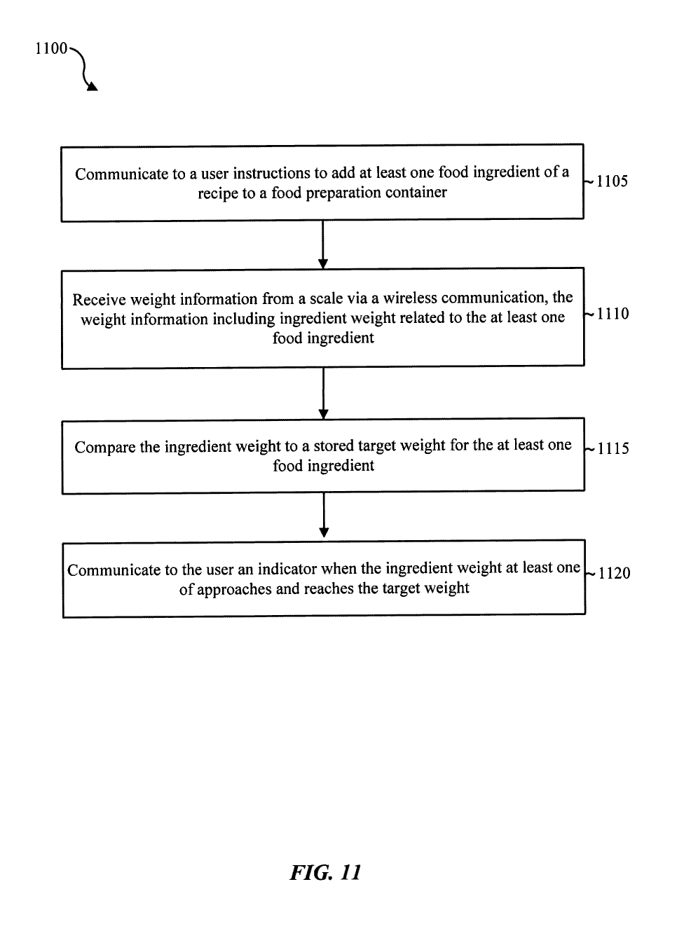

FIG. 11 shows an example food preparation method 1100 in accordance with the present disclosure. Method 1100 may be carried out using any of the features or functionality of the food preparation systems 100, 200 described above with reference to FIGS. 1 and 2, or the features and functionality described with reference to FIGS. 3-5.

The method 1100 may include at block 1105 communicating to a user instructions to add at least one food ingredient of a recipe to the food preparation container. Block 1110 includes receiving weight information from a scale via a wireless communication. The weight information may include ingredient weight related to the at least one food ingredient. Block 1115 includes comparing the ingredient weight to a stored target weight for the at least one food ingredient in accordance with the recipe. Block 1120 includes communicating to the user an indicator when the ingredient weight approaches and/or reaches the target weight.

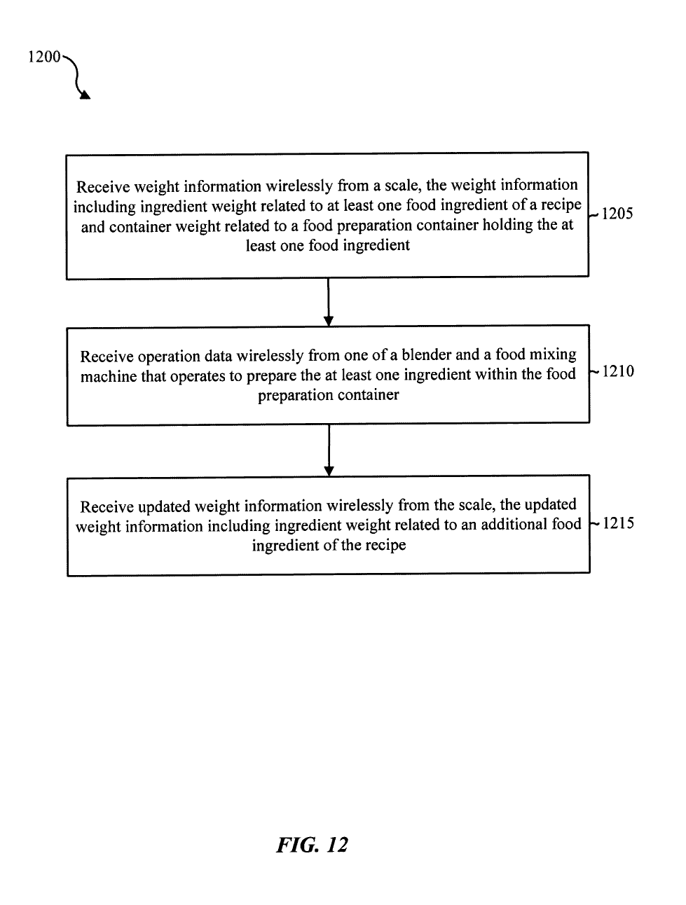

FIG. 12 illustrates another example food preparation method 1200 in accordance with the present disclosure. Method 1200 may be carried out using any of the features or functionality of the food preparation systems 100, 200 described above with reference to FIG. 2, and/or the features and functionality described with reference to FIGS. 3-5.

At block 1205, method 1200 includes receiving weight information wirelessly from a scale. The weight information may include ingredient weight related to at least one food ingredient of a recipe and container weight related to a food preparation container holding the at least one food ingredient. Block 1210 includes receiving operation data wirelessly from one of a blender and a food mixing machine that operates to prepare the at least one ingredient within the food preparation container. Block 1215 includes receiving updated weight information wirelessly from a scale. The updated weight information may include ingredient weight related to an additional food ingredient of the recipe that is added after the blender and/or food mixing machine operation data has been received. Although a blender and food mixing machine are referenced in method 1200, other types of food preparation devices may be used to prepare the at least one ingredient, and operational data associated with any food preparation device may be received and considered as part of carrying out method 1200.

The steps of methods 600, 700, 800, 900, 1000, 1100 and 1200 may be added to, removed or interchanged with each other and/or other method steps in accordance with the present disclosure.

Other capabilities for the food preparation systems described herein may include, for example, detecting accessories, settings, and other operational aspects of one or more food preparation devices that are connected in electronic communication with the recipe module 130 and/or the computing device operating the recipe module 130. The recipe module 130 may adjust a recipe in accordance with the particular features, accessories, and operational data associated with the one or more food preparation devices. The adjustments to the recipe may include, for example, serving size options, weights and/or amounts of ingredients, types of ingredients, duration for mixing and/or blending, mixing and/or blending speeds, or other features and/or functionality related to operation of the food preparation device for that particular recipe.

The food preparation systems disclosed herein may facilitate software upgrades, maintenance information, and other communications with the food preparation devices coupled in communication with the recipe module 130 and/or computing device operating recipe module 130. In one example, the recipe module 130, which is operated by a computing device 115, may receive software updates via network 225 from a central server or backend system. Recipe module 130 may communicate the software updates wirelessly to the food preparation device (e.g., blender 205 and/or food mixing machine 215). The food preparation device may communicate back to the recipe module 130 confirmation that the software is properly loaded and operational, and recipe module 130 may communicate the confirmation information back to the backend system via the network 225. Other types of information such as diagnostics, testing, maintenance information, and the like may be communicated back and forth between food preparation devices, recipe module 130 and/or the associated computing device operating recipe module 130, and other remote systems, servers, personnel, customer service resources, and the like.

The recipe module 130 may provide remote control of one or more food preparation device, such as the blender 205 or food mixing machine 215. The remote control may include automated control of one or more features, settings, etc. The remote control may be provided in response to a recipe step. For example, a recipe may include steps of adding at least one ingredient to a food preparation container (e.g., blender jar 210 or mixing bowl 220) while the food preparation container is supported on a scale (e.g., scale 105), followed by a step of mounting the food preparation container to a food preparation device (e.g., blender 205 or food mixing machine 215). The recipe module 130 may confirm that the food preparation container is properly mounted to the food preparation device, and then automatically operate the food preparation device as part of preparing the ingredients according to the recipe.

While the scale 105 is shown as a separate device from the food preparation devices 205, 215 shown in FIG. 2, some embodiments may include the scale 105 integrated into a food preparation device. For example, blender 205 may include a scale feature that measures the weight of jar 210 and/or the entire blender 205, and/or the ingredients added to jar 210. The scale 105 may operate to weigh the ingredients while the jar 210 is mounted to an operation with a base unit of blender 205.

The ability to weigh ingredients being added to a food preparation container 110 may eliminate the need for separate measuring devices such as measuring cups, measuring spoons, and the like during preparation of a recipe. Furthermore, use of the food preparation container that is itself used with a food preparation device may eliminate the need for a separate food preparation container that must be cleaned and maintained.

The ability to automatically identify a particular food preparation container by its weight information collected by scale 105 may provide a variety of advantages. For example, recipe module 130 may identify a food preparation container as a stainless steel mixing bowl for a food mixing machine. The use of stainless steel for a particular recipe (e.g., whole wheat bread) may require the use of additional flour in the recipe as compared to using a low density polymer mixing bowl. The type of material used for the bowl, the amount of flour or other ingredients, the type of food mixing machine, and other considerations may be taken into account by recipe module 130 in adjusting instructions (e.g., mixing time and mixing speed) as well as the particular ingredients used.

Another advantage associated with recipe module 130 is the ability to receive confirmation from a user of the type and/or state of the ingredients available for the recipe. In one example, recipe module 130 may inquire whether the food ingredient available is frozen or thawed. If the available ingredient is frozen, the recipe may be adjusted to reduce the amount of ice added and increase an amount of water added to the recipe as compared to a thawed ingredient which may require more ice and less water. Recipe module 130 may also provide an option for the user to manually adjust a recipe, such as exchange one ingredient for another. Recipe module 130 may calculate a change in nutritional value, calorie count, etc. in view of the change in ingredient, and display that updated information for the user's benefit.

The database of information available to recipe module 130 may be updated and made available after the components of the food preparation systems disclosed herein have been purchased and are in use. For example, database 230 may be updated with additional information about new food container models, food preparation devices and their associated food preparation containers, recipes, ingredients, nutritional information, and the like. The information in database 230 may be readily available to computing device 115 and recipe module 130 for use by a user. Such updates may be made available without the user having to manually update and/or sync with database 230. Similarly, the software updates, instructions, maintenance information, diagnostics, and the like may be automatically transmitted from e food preparation devices (e.g., blender 205 and food mixing machine 215) to the recipe module 130 and/or backend servers and the like via network 225 and other wireless and/or wired communications.

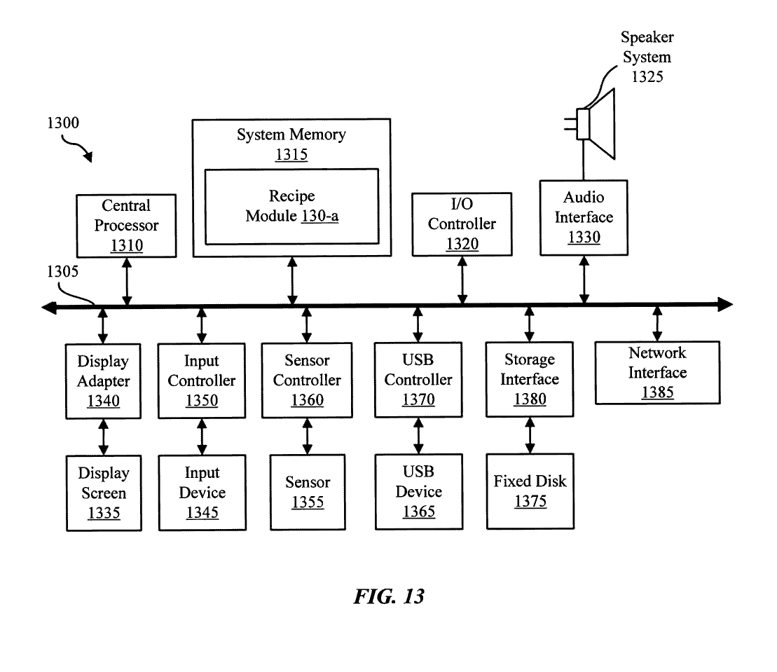

FIG. 13 depicts a block diagram of a computer system 1300 suitable for implementing the present systems and methods. The computer system 1300 may be part of the food preparation systems 100, 200 of the present disclosure. Computer system 1300 includes a bus 1305 which interconnects major subsystems of computer system 1300, such as a central processor 1310, a system memory 1315 (typically RAM, but which may also include ROM, flash RAM, or the like), an input/output controller 1320, an external audio device, such as a speaker system 1325 via an audio output interface 1330, an external device, such as a display screen 1335 via display adapter 1340, an input device 1345 (e.g., a keyboard, touchscreen, etc.) (interfaced with an input controller 1350), a sensor 1355 (interfaced with a sensor controller 1360), one or more universal serial bus (USB) device 1365 (interfaced with a USB controller 1360), and a storage interface 1380 linking to a fixed disk 1375. A network interface 1385 is also included and coupled directly to bus 1305.

Bus 1305 allows data communication between central processor 1310 and system memory 1315, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a recipe module 130-a which may implement the present systems and methods may be stored within the system memory 1315. Applications resident with computer system 1300 are generally stored on and accessed via a non-transitory computer readable medium, such as a hard disk drive (e.g., fixed disk 1375), an optical drive (e.g., an optical drive that is part of a USB device 1365 or that connects to storage interface 1380), or other storage medium. Additionally, applications can be in the form of electronic signals modulated in accordance with the application and data communication technology when accessed via network interface 1385.

Storage interface 1380, as with the other storage interfaces of computer system 1300, can connect to a standard computer readable medium for storage and/or retrieval of information, such as a fixed disk drive 1375. Fixed disk drive 1375 may be a part of computer system 1300 or may be separate and accessed through other interface systems. A modem connected to the network interface 1385 may provide a direct connection to a remote server via a telephone link or to the Internet via an internet service provider (ISP). Network interface 1385 may provide a direct connection to a remote server via a direct network link to the Internet via a POP (point of presence). Network interface 1385 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 13 need not be present to practice the present systems and methods. The devices and subsystems can be interconnected in different ways from that shown in FIG. 13. The operation of a computer system such as that shown in FIG. 13 is readily known in the art and is not discussed in detail in this application. Code to implement the present disclosure can be stored in a non-transitory computer-readable medium such as one or more of system memory 1315, or fixed disk 1375. The operating system provided on computer system 1300 may be MS-DOS®, MS-WINDOWS®, OS/2®, UNIX®, Linux®, or another known operating system.

Moreover, regarding the signals and network communications described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiments are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A food preparation system, comprising:
an application operable by a computing device;
a scale configured to support a food preparation container and communicate weight information associated with the food preparation container wirelessly to the computing device;
wherein the application coordinates the weight information with ingredients of a recipe.

2. The food preparation system of claim 1, further comprising:
a blender having a removable blending jar, wherein the food preparation container comprises the removable blending jar.

3. The food preparation system of claim 1, further comprising:
a food mixing machine having a removable bowl, wherein the food preparation container comprises the removable bowl.

4. The food preparation system of claim 1, wherein the computing device communicates with the scale using a wireless connection.

5. The food preparation system of claim 1, wherein the application identifies the food preparation container based on the weight information.

6. The food preparation system of claim 1, wherein the application communicates information to one or more users corresponding to weight of one or more ingredients relative to a target weight for the one or more ingredients.

7. The food preparation system of claim 1, wherein the application communicates the information via at least one of a speaker or display screen of the computing device.

8. The food preparation system of claim 1, wherein the application is operable to receive inputs from a user regarding at least one of available ingredients, serving size, and condition of ingredients.

9. A weighing method, comprising:
receiving weight information from a scale via a wireless communication, the weight information including at least a container weight of a food preparation container supported on the scale;
comparing the container weight to stored weight information for a plurality of different food preparation containers;
automatically identifying the food preparation container based on the comparison.

10. The method of claim 9, wherein the weight information includes ingredient weight of one or more food ingredients held in the food preparation container, the method further comprising:
comparing the ingredient weight to a target ingredient weight for a recipe.

11. The method of claim 9, wherein the weight information includes ingredient weight of one or more food ingredients held in the food preparation container, the method further comprising:
generating an indicator when the ingredient weight at least one of approaches and reaches a target weight for a recipe.

12. The method of claim 11, wherein the indicator is a visual display of at least one of a color scheme, a numerical value, and a graphical object.

13. The method of claim 11, wherein the indicator is an audio or tactile indicator.

14. A food preparation method, comprising:
communicating to a user instructions to add at least one food ingredient of a recipe to a food preparation container;
receiving weight information from a scale via a wireless communication, the weight information including ingredient weight related to the at least one food ingredient;
comparing the ingredient weight to a stored target weight for the at least one food ingredient;
communicating to the user an indicator regarding the ingredient weight.

15. The method of claim 14, further comprising receiving mixing information from a food mixture machine related to mixing the at least one food ingredient in the food preparation container.

16. The method of claim 14, wherein the indicator is at least one of a displayed color scheme, a displayed numerical value, a displayed graphical object, and an audio message.

17. The method of claim 16, wherein the displayed graphical object illustrates the ingredient weight disproportionately relative to the target weight.

18. The method of claim 16, wherein the color scheme includes changing colors as the ingredient weight approaches and then reaches the target weight.

19. The method of claim 16, wherein the numerical value is at east one of a percentage of the ingredient weight relative to the target weight, and the ingredient weight.

20. The method of claim 14, further comprising:
displaying all ingredients of the recipe prior to ingredients being added to the food preparation container, and removing ingredients from the display as the target weight for each ingredient is met.

21. The method of claim 14, further comprising:
wirelessly connecting to at least one of a blender and a food mixing machine, and the food preparation container is at least one of a jar of the blender and a bowl of the food mixing machine.

22. The method of claim 14, further comprising:
receiving modifications to the recipe via at least one manual input from a user.

23. The method of claim 14, further comprising:
displaying at least one question related to the at least one food ingredient;
receiving a response to the question from one or more users.

24. The method of claim 23, further comprising:
adjusting at least one of an amount of the at least one ingredient, an instruction of the recipe, and an amount of another ingredient of the recipe in response to the response.

25. The method of claim 23, wherein the question relates to at least one of a sweetness scale and a healthy scale for the recipe, the method further comprising:
adjusting at least one of a sugar content and a calorie content of the recipe based at least in part of the user's response to the question about the sweetness scale and the healthy scale.

25. A food preparation method, comprising:
receiving weight information wirelessly from a scale, the weight information including ingredient weight related to at least one food ingredient of a recipe and container weight related to a food preparation container holding the at least one food ingredient;
receiving operation data wirelessly from one of a blender and a food mixing machine that operates to prepare the at least one ingredient within the food preparation container;
receiving updated weight information wirelessly from the scale, the updated weight information including ingredient weight related to an additional food ingredient of the recipe.

26. The method of claim 25, wherein the operation data includes at least one of power consumption, load, operation speed, and operation duration.

27. The method of claim 25, further comprising:
delivering software updates to at least one of the scale, the blender, and the food mixing machine.

28. The method of claim 25, wherein the weight information and the operation data are received at a mobile computing device.

29. The method of claim 25, further comprising:
adjusting the recipe based at least in part on the operation data.

30. The method of claim 25, further comprising:
controlling the at least one of a blender and a food mixing machine wirelessly.
